(19) United States
(12) Patent Application Publication
(10) Pub. No.: US 2025/0337005 A1
(43) Pub. Date: Oct. 30, 2025

(54) HYBRID ALL-SOLID-STATE SECONDARY BATTERY AND METHOD OF MANUFACTURING THE SAME

(71) Applicant: EBS SQUARE, Inc., Gyeonggi-do (KR)

(72) Inventors: SUNGWON HWANG, Gyeonggi-do (KR); KWAN SUN PARK, Gyeonggi-do (KR)

(73) Assignee: EBS SQUARE, Inc., Gyeonggi-do (KR)

(21) Appl. No.: 18/882,378

(22) Filed: Sep. 11, 2024

(30) Foreign Application Priority Data
Apr. 26, 2024 (KR) 10-2024-0056032

(51) Int. Cl. H01M 10/0562; H01M 4/02; H01M 4/131; H01M 4/133

(52) U.S. Cl. CPC H01M 10/0562; H01M 4/131; H01M 4/133; H01M 2004/021; H01M 2300/0077; H01M 2300/0091

(57) ABSTRACT

A solid electrolyte includes an oxide solid electrolyte layer, and a sulfide solid electrolyte layer, and the oxide solid electrolyte layer and the sulfide solid electrolyte layer are doped with graphene quantum dots (GQDs).

### CROSS-REFERENCE TO RELATED APPLICATION

This application claims the benefit of Korean Patent Application No. 10-2024-0056032, filed on Apr. 26, 2024, in the Korean Intellectual Property Office, the entire disclosure of which is incorporated herein by reference for all purposes.

### BACKGROUND

### 1. Field of the Invention

One or more embodiments relate to a hybrid all-solid-state secondary battery and a method of manufacturing the hybrid all-solid-state secondary battery.

### 2. Description of the Related Art

Recently, technological development and advancement of lithium-ion batteries (LIBs) have been achieved by supplying power to portable electronic devices. In particular, it is predicted that the LIB market needs to expand to meet demands for secondary batteries due to an increase in the traveling range of electric vehicles and an increase in interest in clean energy. However, the above development may be hindered by some obstacles, and safety hazards caused by the possibility of battery thermal runaway and explosion are emerging as major issues. Such disadvantages arise from highly flammable organic liquid electrolytes included in batteries.

To overcome the above issues, manufacturing of an all-solid-state battery (ASSB) by replacing a liquid electrolyte with a solid compound is an interesting approach to lead LIB technology to the next level. Therefore, solid electrolytes are gaining attention as an alternative because solid electrolytes are non-flammable and exhibit high thermal and electrochemical stability, high energy density, and mechanical stability even after stress such as cutting or bending is applied to the solid electrolytes.

Among oxide-based solid electrolytes, a cubic garnet-type structure is regarded as a promising candidate for the application of a solid electrolyte of an ASSB. Previous studies have confirmed that garnet oxides include Li₅La₃NbO₁₂ (LLNO) and Li₇La₃Zr₂O₁₂ (LLZO). Amounts of lithium (Li) in compounds are different due to a charge balance resulting from oxidation states of cations at octahedral sites (i.e., Nb5+ and Zr4+). Lithium ion conductivities of the above materials have been reported to be on the order of 10⁻⁵ to 10⁻⁷ siemens per centimeter (S cm⁻¹) for an LLNO, and 10⁻⁴ S cm⁻¹ for an LLZO at room temperature. Atomic substitution has been studied to increase the ion conductivity of the LLZO and prevent a formation of a tetragonal phase. In other words, it has been demonstrated that an ion conductivity of an LLZO-doped compound with a formula Li₇₋ₓLa₃(Zr₂₋ₓMₓ)O₁₂ (M=Nb⁵⁺, Ta⁵⁺) is increased by at least a single digit. Such a change in the ion conductivity depends on a cation dopant and a concentration with activation energy in a range of 0.3 to 0.4 eV.

In general, various synthesis methods have been applied to generate a cubic garnet solid solution, including a co-precipitation method, a sol-gel method, a spray pyrolysis method, and a solid-phase reaction method. A wet chemical synthesis may reduce a sintering temperature and an active material reaction time due to a reduction in the size of particles, however, a high-temperature sintering condition required to obtain dense pellets may be detrimental to a phase stability due to a loss of Li.

The above description is information the inventor(s) acquired during the course of conceiving the present disclosure, or already possessed at the time, and is not necessarily art publicly known before the present application was filed.

### SUMMARY

One or more embodiments provide a hybrid all-solid-state secondary battery and a method of manufacturing the hybrid all-solid-state secondary battery.

Specifically, according to embodiments, to further increase an ion conductivity of an oxide-based solid electrolyte, an argyrodite-type sulfide-based solid electrolyte may be mixed. Since a temperature and pressure are simultaneously applied in a plasma heat treatment method (e.g., spark plasma sintering (SPS)) and pulsed laser annealing technology used in the present disclosure, a relatively low temperature and a relatively short reaction time may be applied in comparison to existing processes.

However, goals to be achieved by the present disclosure are not limited to those described above, and other goals not mentioned above can be clearly understood by one of ordinary skill in the art from the following description.

According to an aspect, there is provided a solid electrolyte including an oxide solid electrolyte layer, and a sulfide solid electrolyte layer. The oxide solid electrolyte layer and the sulfide solid electrolyte layer may be doped with graphene quantum dots (GQDs).

The oxide solid electrolyte layer may include at least one of a lithium lanthanum zirconium oxide (LLZO), lithium perovskite, a lithium superionic conductor (LISICON), lithium garnet, doped lithium garnet, and a mixture thereof.

The sulfide solid electrolyte layer may include at least one of an amorphous lithium phosphorus sulfur chloride (LPSCl)-based solid electrolyte, a crystalline LPSCl-based solid electrolyte, and an amorphous and crystalline LPSCl-based solid electrolyte.

The oxide solid electrolyte layer and the sulfide solid electrolyte layer may each have a thickness of 0.1 micrometers (μm) to 50 μm.

The GQDs may be used in an amount of 5 parts by weight to 30 parts by weight to dope 100 parts by weight of the oxide solid electrolyte layer and the sulfide solid electrolyte layer.

The GQDs may have a diameter of 5 nanometers (nm) to 50 nm. The GQDs may have a crystalline structure, or have an amorphous region of 5% or less in a structure of the GQDs.

The oxide solid electrolyte layer may be in an amount of 10% by weight (wt %) to 90 wt % in the solid electrolyte, and the sulfide solid electrolyte layer may be in an amount of 10 wt % to 90 wt % in the solid electrolyte.

The solid electrolyte may have a lithium ion conductivity of 1×10⁻⁴ siemens per centimeter (S/cm) to 9×10⁻³ S/cm.

According to another aspect, there is provided an all-solid-state secondary battery including an anode layer, a first nanoparticle layer formed on the anode layer, a solid electrolyte layer formed on the first nanoparticle layer, a second nanoparticle layer formed on the solid electrolyte layer, and a cathode layer formed on the second nanoparticle layer. The solid electrolyte layer may include the solid electrolyte described above.

The first nanoparticle layer may include hydroxyl group-containing graphene quantum dots (OH-GQDs), and the second nanoparticle layer may include a nickel-cobalt-manganese ternary active material (NCM).

The nickel-cobalt-manganese ternary active material (NCM) may be doped with GQDs, and the GQDs may be used in an amount of 5 parts by weight to 30 parts by weight to dope 100 parts by weight of the nickel-cobalt-manganese ternary active material (NCM).

The first nanoparticle layer and the second nanoparticle layer may each have a thickness of 10 μm to 70 μm.

The first nanoparticle layer may be in an amount of 10 wt % to 40 wt % in the all-solid-state secondary battery, and the second nanoparticle layer may be in an amount of 20 wt % to 60 wt % in the all-solid-state secondary battery.

The all-solid-state secondary battery may have a capacity retention of 96.9% or greater after “500” cycles at 25° C.

Additional aspects of embodiments will be set forth in part in the description which follows and, in part, will be apparent from the description, or may be learned by practice of the disclosure.

According to embodiments, a hybrid all-solid-state secondary battery, and a method of manufacturing the hybrid all-solid-state secondary battery may be provided.

According to embodiments, a solid electrolyte may be a hybrid with a controllable ion conductivity, including LPSCL that is an argyrodite-type sulfide-based solid electrolyte, and LLZO that is a garnet-type oxide-based solid electrolyte, by optimizing an amount (wt %) of GQDs for doping, and may have an advantage of a high-ion conductivity hybrid garnet structure, and thus, a method of designing a high-ion conductivity structure of an all-solid-state secondary battery and manufacturing the all-solid-state secondary battery may be provided. A hybrid all-solid-state secondary battery may be applied to electric vehicle electronics, and IT products, such as mobile phones or displays. In addition, since sintering is performed using a dry method, that is, a plasma heat treatment method and a pulsed laser annealing method, instead of using a wet method, high-density pellets may be produced through a synthesis by a solid particle reaction and at a low temperature (e.g., a temperature of 650° C. or less) and in a short heat treatment reaction time (e.g., four hours or less). Thus, the hybrid all-solid-state secondary battery may be useful for low-cost mass production processes.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a structure of an all-solid-state secondary battery according to an embodiment;

FIG. 2 illustrates a method of preparing a solid electrolyte according to an embodiment;

FIG. 3 illustrates a method of preparing a first nanoparticle layer and a second nanoparticle layer of an all-solid-state secondary battery according to an embodiment;

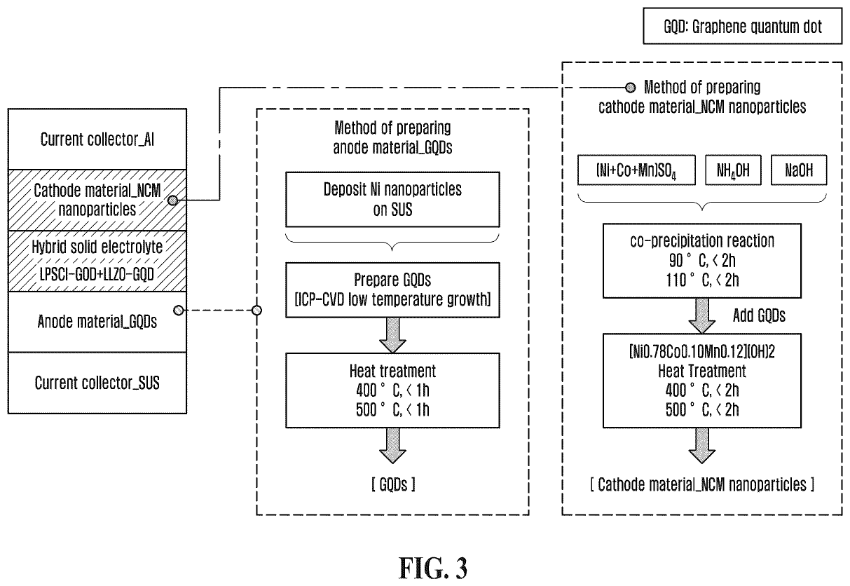

FIGS. 4A and 4B illustrate X-ray diffraction (XRD) patterns of sintered pellets of a sulfide solid electrolyte layer and an oxide solid electrolyte layer based on an amount (% by weight (wt %)) of graphene quantum dots (GQDs), respectively, according to an embodiment;

FIGS. 5A and 5B illustrate results of a Raman spectroscopy analysis of a sulfide solid electrolyte layer and an oxide solid electrolyte layer based on an amount (wt %) of GQDs, respectively, according to an embodiment;

FIG. 6A illustrates results of an electrochemical impedance spectroscopy (EIS) analysis of solid electrolyte pellets, and FIG. 6B illustrates a proportion of a cubic phase based on a molar concentration of lithium ions (Li+), according to an embodiment;

FIG. 7A illustrates activation energy of solid electrolyte pellets based on an amount (wt %) of GQDs, and FIG. 7B illustrates a change in an amount of lithium ions (Li⁺) after the solid electrolyte pellets are sintered and analyzed through an inductively coupled plasma atomic emission spectroscopy (ICP-AES) measurement, according to an embodiment;

FIGS. 8A and 8B illustrate results obtained by measuring lithium ion conductivities of solid electrolyte pellets at room temperature using an alternating current impedance analysis according to an embodiment;

FIG. 9 illustrates images representing characteristics of microstructures for each layer of an all-solid-state secondary battery according to an embodiment;

FIGS. 10A and 10B illustrate a charge-discharge profile of an all-solid-state secondary battery formation cycle according to an embodiment; and

FIG. 11 illustrates a discharge capacity of an all-solid-state secondary battery for “500” cycles under a condition of 0.1 C at 300 K according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure. In addition, the terms first, second, A, B, (a), and (b) may be used to describe components of the embodiments. These terms are used only for the purpose of discriminating one component from another component, and the nature, the sequences, or the orders of the components are not limited by the terms. It should be noted that if it is described in the specification that one component is “connected,” “coupled” or “joined” to another component, the former may be directly “connected,” “coupled,” and “joined” to the latter or “connected,” “coupled,” and “joined” to the latter via another component.

Components included in one embodiment and components having a common function will be described using the same names in other embodiments. Unless otherwise mentioned, the descriptions on the embodiments may be applicable to the following embodiments and thus, duplicated descriptions will be omitted for conciseness.

A solid electrolyte according to an embodiment may include an oxide solid electrolyte layer, and a sulfide solid electrolyte layer, and the oxide solid electrolyte layer and the sulfide solid electrolyte layer may be doped with graphene quantum dots (GQDs).

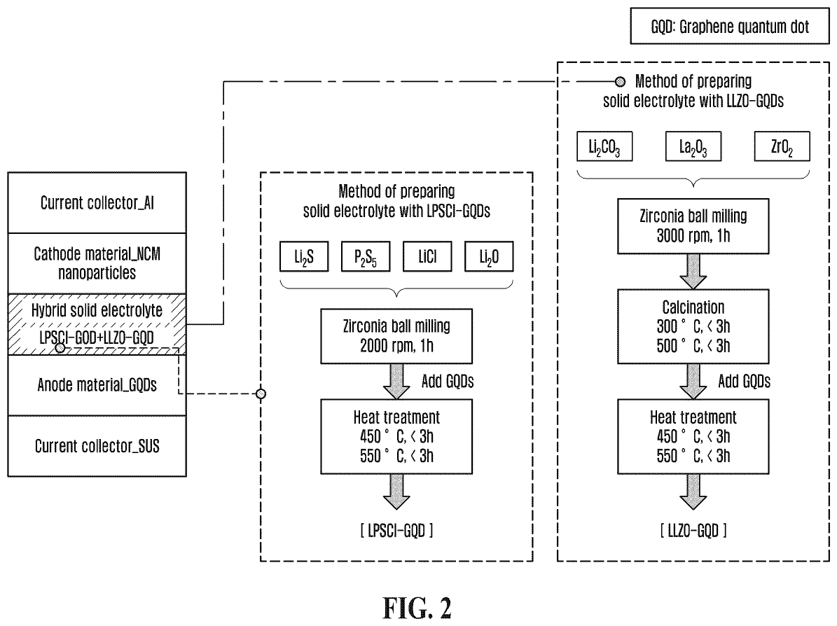

FIG. 2 illustrates a method of preparing a solid electrolyte according to an embodiment.

FIG. 2 illustrates a method of preparing an oxide solid electrolyte layer and a method of preparing a sulfide solid electrolyte layer. A synthesis of the solid electrolyte for manufacturing of a hybrid all-solid-state secondary battery may be synthesizing of the oxide solid electrolyte layer and the sulfide solid electrolyte layer using a mechanical milling method. The synthesis of the solid electrolyte may be synthesizing of a solid electrolyte in an amorphous state by inducing a mechanochemical reaction.

According to an embodiment, the solid electrolyte may be synthesized using a plasma heat treatment method (e.g., spark plasma sintering (SPS)) and pulsed laser annealing, and a temperature and pressure may be simultaneously applied, and accordingly, a relatively low temperature and relatively short reaction time may be applied in comparison to existing processes. In addition, if a cation substitution and a plasma heat treatment method are combined to produce a solid electrolyte with a high density, an ion conductivity of the solid electrolyte may be enhanced.

According to an embodiment, the oxide solid electrolyte layer may include at least one of a lithium lanthanum zirconium oxide (LLZO), lithium perovskite, a lithium superionic conductor (LISICON), lithium garnet, doped lithium garnet, and a mixture thereof.

According to an embodiment, the LLZO may be represented by Chemical Formula 1 shown below.

LiₓLa_{y}Zr_{z}O₁₂ (6≤x≤9, 2≤y≤4, 1≤z≤3) [Chemical Formula 1]

According to an embodiment, the lithium perovskite may be Li_{2x-y}Sr₁₋ₓTi_{1-y}Nb_{y}O₃ (in which y is 0.5, x is 0.375), or Li₃ₐL_{n(2/3)-a(1/3)-2a}TiO₃ or Li₃ₐLn_{0.67-a}TiO₃ (in which Ln is lanthanide, 0<a≤0.16, for example, 0.04≤a≤0.15, for example, a=0.1 or a=0.11) that is a perovskite-type lithium lanthanide titanate (LLTO), but is not limited thereto. For example, the lithium perovskite may be Li_{0.25}Sr_{0.625}Ti_{0.5}Nb_{0.5}O or Li_{0.3}La_{0.57}TiO₃.

According to an embodiment, the LISICON may be A_{1+b}[M¹₂₋₆M²_{b}(PO₄)₃] (in which A is Li or Na, M1 is selected from Ge, Ti, Zr, or a mixture thereof, M2 is selected from Al, Cr, Ga, Fe, Sc, In, Lu, Y, La, or a mixture thereof, and 0≤b≤1), Li_{2+2c}Zn_{1-c}GeO₄ (0<c<1, and lithium germanium sulfide (Li_{4+d}Ge_{1-d}Ga_{d}S₄ (0.15≤d≤0.35)), or lithium germanium/silicon/phosphorus sulfide (Li₄₋ₑ(Ge/Si)₁₋ₑPₑS₄ (0.5≤e≤1)), but is not limited thereto. For example, the LISICON may be LiGe₂(PO₄)₃, Li_{1.3}Al_{0.3}Ti_{1.7} (PO₄)₃ (LATP), Li₁₄ZnGe₄O₁₆, Li_{3.25}Ge_{0.25}P_{0.75}S₄, or Li_{3.4}Si_{0.4}P_{0.6}S₄.

According to an embodiment, the lithium garnet may be Li_{A}La_{B}M′_{C}M″_{D}Zr_{E}O_{F} (5<A<8, 1.5<B<4, 0.1≤C≤2, 0<D≤2; 1≤E≤2, 10<F≤13, M′ may be Al, and M″ may be Mo, W, Nb, Sb, Ca, Ba, Sr, Ce, Hf, or Rb), LiₓLa_{y}Zr_{z}Al_{w}O₁₂ (5≤x≤9, 2≤y≤4, 1≤z≤3, 0<w≤1), LiₓLa_{y}Z_{z}O₁₂ (6≤x≤9, 2≤y≤4, 1≤z≤3), Li₃Ln₃Te₂O₁₂ (Ln=Y, Pr, Nd, Sm—Lu), Li₅La₃M₂O₁₂ (M=Nb, Ta, Sb), Li₆ALa₂M₂O₁₂ (A=Mg, Ca, Sr; M=Nb, Ta), Li₇La₃M₂O₁₂ (M=Zr, Sn), and the like, but is not limited thereto.

According to an embodiment, the sulfide solid electrolyte layer may include at least one of an amorphous lithium phosphorus sulfur chloride (LPSCl)-based solid electrolyte, a crystalline LPSCl-based solid electrolyte, and an amorphous and crystalline LPSCl-based solid electrolyte.

According to an embodiment, the sulfide solid electrolyte layer may include a sulfide-based particle. A surface of the sulfide-based particle may be coated or modified to be used, and a dry process or wet process may be performed on a mixture including the sulfide-based particle, to prepare a sulfide-based solid electrolyte. The sulfide-based particle is not particularly limited in the present disclosure and may include all sulfide-based materials known and used in the field of lithium batteries.

According to an embodiment, the sulfide solid electrolyte may be Li₆PS₅Cl (LPSCl), Li_{3.25}Ge_{0.25}P_{0.75}S₄ (thio-LISICON), Li₂S—P₂S₅—LiCl, Li₂S—SiS₂, Li₂S—GeS₂, Li₂S—GeS₂—P₂S₅, Li₂S—B₂S₃, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₂P₃S₁₁, LiI—Li₂S—B₂S₃, Li₃PO₄—Li₂S—Si₂S, Li₃PO₄—Li₂S—SiS₂, LiPO₄—Li₂S—SiS, Li₁₀GeP₂S₁₂, Li_{9.54}Si_{1.74}P_{1.44}S_{11.7}Cl_{0.3}, Li₇P₃S₁₁, Li_{9.6}P₃S₁₂, Li₇PS₆, Li₆PS₅Br, Li₆PS₅I, and the like, but is not limited thereto.

According to an embodiment, the sulfide solid electrolyte layer may have a structure selected from an amorphous structure, a crystalline structure or an amorphous-crystalline structure. Since relatively small particles are included in the amorphous structure in comparison to the crystalline structure, the amorphous structure may have an advantage of preparing a thin solid electrolyte layer. A crystalline solid electrolyte may have an excellent conductivity despite a relatively large diameter of particles in comparison to the amorphous structure. Thus, according to use of an all-solid-state battery, amorphous, crystalline, or amorphous-crystalline solid electrolyte may be selected.

According to an embodiment, the oxide solid electrolyte layer and the sulfide solid electrolyte layer may each have a thickness of 0.1 micrometers (μm) to 50 μm.

According to an embodiment, the oxide solid electrolyte layer and the sulfide solid electrolyte layer may each have a thickness of 0.1 μm to 50 μm; 0.1 μm to 40 μm; 0.1 μm to 30 μm; 0.1 μm to 20 μm; 0.1 μm to 10 μm; 0.1 μm to 5 μm; 0.1 μm to 1 μm; 0.5 μm to 50 μm; 1 μm to 50 μm; 5 μm to 50 μm; 10 μm to 50 μm; 20 μm to 50 μm; 30 μm to 50 μm; 40 μm to 50 μm; 1 μm to 10 μm; and 5 μm to 20 μm.

According to an embodiment, when the thickness of each of the oxide solid electrolyte layer and the sulfide solid electrolyte layer is less than 0.1 μm, an issue may occur in a function of a separator of the solid electrolyte, which may lead to a short circuit issue that is difficult to control. When the thickness exceeds 50 μm, an issue of the ion conductivity of lithium ions may occur due to an increase in an interface resistance between different materials.

According to an embodiment, the GQDs may be used in an amount of 5 parts by weight to 30 parts by weight to dope 100 parts by weight of the oxide solid electrolyte layer and the sulfide solid electrolyte layer.

According to an embodiment, the GQDs may be used in an amount of 5 parts by weight to 30 parts by weight; 7 parts by weight to 30 parts by weight; 9 parts by weight to 30 parts by weight; 11 parts by weight to 30 parts by weight; 13 parts by weight to 30 parts by weight; 15 parts by weight to 30 parts by weight; 17 parts by weight to 30 parts by weight; 20 parts by weight to 30 parts by weight; 25 parts by weight to 30 parts by weight; 5 parts by weight to 25 parts by weight; 5 parts by weight to 20 parts by weight; 5 parts by weight to 15 parts by weight; 5 parts by weight to 10 parts by weight; 5 parts by weight to 8 parts by weight; 10 parts by weight to 15 parts by weight; and 12 parts by weight to 20 parts by weight, to dope 100 parts by weight of the oxide solid electrolyte layer and the sulfide solid electrolyte layer.

According to an embodiment, when the amount of GQDs to be used to dope 100 parts by weight of the oxide solid electrolyte layer and the sulfide solid electrolyte layer is less than 5 parts by weight, it may be difficult to improve the ion conductivity due to a limitation on a function of increasing the conductivity while protecting defects included in a solid electrolyte matrix, because the GQDs have a structure with an excellent conductivity without defects. When the amount of GQDs to be used to dope 100 parts by weight of the oxide solid electrolyte layer and the sulfide solid electrolyte layer exceeds 30 parts by weight, an issue of an interface resistance within the solid electrolyte matrix may occur due to an occurrence of an issue in aggregation between GQDs.

According to an embodiment, the GQDs may have a diameter of 5 nanometers (nm) to 50 nm. The GQDs may have a crystalline structure, or have an amorphous region of 5% or less in a structure of the GQDs.

According to an embodiment, the GQDs may have a diameter of 5 nm to 50 nm; 7 nm to 50 nm; 9 nm to 50 nm; 10 nm to 50 nm; 15 nm to 50 nm; 20 nm to 50 nm; 25 nm to 50 nm; 30 nm to 50 nm; 35 nm to 50 nm; 40 nm to 50 nm; 45 nm to 50 nm; 5 nm to 40 nm; 5 nm to 30 nm; 5 nm to 20 nm; 5 nm to 10 nm; 10 nm to 30 nm; and 20 nm to 40 nm.

According to an embodiment, when the diameter of the GQDs is less than 5 nm, it may be impossible to control a zigzag and armchair structure in an atom layer, which may cause an issue of a control of a uniform shape. When the diameter of the GQDs exceeds 50 nm, a defect density may increase, which may cause an issue of a control of a uniform shape.

According to an embodiment, the GQDs may have a crystalline structure, or a crystalline and amorphous structure. For example, the amorphous region may be 5% or less; 4% or less; 3% or less; or 2% or less of the structure of the GQDs.

According to an embodiment, the oxide solid electrolyte layer may be in an amount of 10% by weight (wt %) to 90 wt % in the solid electrolyte, and the sulfide solid electrolyte layer may be in an amount of 10 wt % to 90 wt % in the solid electrolyte.

According to an embodiment, the oxide solid electrolyte layer may be in an amount of 10 wt % to 90 wt %; 20 wt % to 90 wt %; 30 wt % to 90 wt %; 40 wt % to 90 wt %; 50 wt % to 90 wt %; 60 wt % to 90 wt %; 70 wt % to 90 wt %; 80 wt % to 90 wt %; 10 wt % to 80 wt %; 10 wt % to 70 wt %; 10 wt % to 60 wt %; 10 wt % to 50 wt %; 10 wt % to 40 wt %; 10 wt % to 30 wt %; 10 wt % to 20 wt %; 20 wt % to 50 wt %; and 40 wt % to 80 wt % in the solid electrolyte.

According to an embodiment, when the amount of the oxide solid electrolyte layer in the solid electrolyte is less than 10 wt %, an issue of a resistance at an interface between a cathode material and an anode material may occur. When the amount of the oxide solid electrolyte layer in the solid electrolyte exceeds 90 wt %, it may be difficult to improve the ion conductivity.

According to an embodiment, the sulfide solid electrolyte layer may be in an amount of 10 wt % to 90 wt %; 20 wt % to 90 wt %; 30 wt % to 90 wt %; 40 wt % to 90 wt %; 50 wt % to 90 wt %; 60 wt % to 90 wt %; 70 wt % to 90 wt %; 80 wt % to 90 wt %; 10 wt % to 80 wt %; 10 wt % to 70 wt %; 10 wt % to 60 wt %; 10 wt % to 50 wt %; 10 wt % to 40 wt %; 10 wt % to 30 wt %; 10 wt % to 20 wt %; 20 wt % to 50 wt %; and 40 wt % to 80 wt % in the solid electrolyte.

According to an embodiment, when the amount of the sulfide solid electrolyte layer in the solid electrolyte is out of the above-described ranges, it may be difficult to improve the ion conductivity.

According to an embodiment, the solid electrolyte may have a lithium ion conductivity of 1×10⁻⁴ siemens per centimeter (S/cm) to 9×10⁻³ S/cm.

According to an embodiment, the solid electrolyte may have a lithium ion conductivity of 1×10⁻⁴ S/cm to 9×10⁻³ S/cm; 3×10⁻⁴ S/cm to 9×10⁻³ S/cm; 5×10⁻⁴ S/cm to 9×10⁻³ S/cm; 7×10⁻⁴ S/cm to 9×10⁻³ S/cm; 9×10⁻⁴ S/cm to 9×10⁻³ S/cm; 1×10⁻³ S/cm to 9×10⁻³ S/cm; 3×10⁻³ S/cm to 9×10⁻³ S/cm; 5×10⁻³ S/cm to 9×10⁻³ S/cm; 7×10−³ S/cm to 9×10⁻³ S/cm; 1×10⁻⁴ S/cm to 7×10⁻³ S/cm; 1×10⁻⁴ S/cm to 5×10⁻³ S/cm; 1×10⁻⁴ S/cm to 3×10⁻³ S/cm; 1×10⁻⁴ S/cm to 1×10⁻³ S/cm; 1×10⁻⁴ S/cm to 9×10⁻⁴ S/cm; 1×10⁻⁴ S/cm to 7×10⁻⁴ S/cm; 1×10⁻⁴ S/cm to 5×10⁻⁴ S/cm; and 1×10⁻⁴ S/cm to 3×10⁻⁴ S/cm.

According to an embodiment, when the lithium ion conductivity of the solid electrolyte is less than 1×10⁻⁴ S/cm, it may be difficult to improve the ion conductivity. When the lithium ion conductivity of the solid electrolyte exceeds 9×10⁻³ S/cm, an issue of a resistance at an interface between a cathode material and an anode material may occur.

According to an embodiment, an all-solid-state secondary battery may include an anode layer, a first nanoparticle layer formed on the anode layer, a solid electrolyte layer formed on the first nanoparticle layer, a second nanoparticle layer formed on the solid electrolyte layer, and a cathode layer formed on the second nanoparticle layer. The solid electrolyte layer may include the solid electrolyte described above.

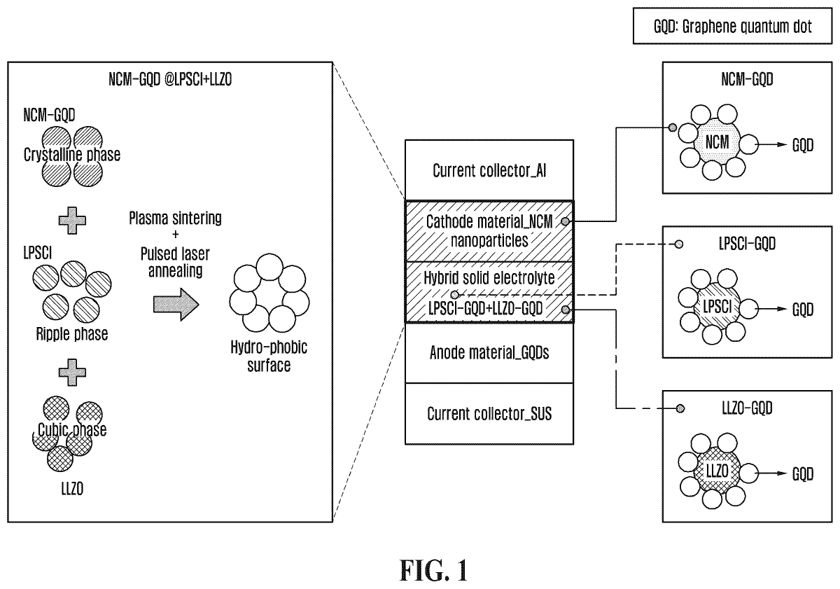

FIG. 1 is a diagram illustrating a structure of an all-solid-state secondary battery according to an embodiment. Referring to FIG. 1, the all-solid-state secondary battery may include an anode layer including a stainless steel (SUS) current collector, a first nanoparticle layer formed on the anode layer, a solid electrolyte layer formed on the first nanoparticle layer, a second nanoparticle layer formed on the solid electrolyte layer, and a cathode layer formed on the second nanoparticle layer and including an aluminum (Al) current collector. The solid electrolyte layer may include a solid electrolyte including an oxide solid electrolyte layer and a sulfide solid electrolyte layer. The oxide solid electrolyte layer and the sulfide solid electrolyte layer may be doped with GQDs. The oxide solid electrolyte layer may include LLZO-GQDs, and the sulfide solid electrolyte layer may include LPSCL-GQDs. The first nanoparticle layer may include hydroxyl group-containing graphene quantum dots (OH-GQDs), and the second nanoparticle layer may include a nickel-cobalt-manganese ternary active material (NCM) doped with GQDs.

According to an embodiment, the anode layer may include a lithium metal film including a lithium metal or a lithium alloy.

According to an embodiment, the cathode layer may further include a conductive material, a polymer solid electrolyte (e.g., a polymer electrolyte, and a lithium salt complex), a lithium salt (LiX in which X is at least one of ClO₄, PF₆, BF₄, CF₃SO₃, or N (CF₃SO₂)₂ or a combination thereof), or both. The conductive material may be, but is not limited to, carbon black, acetylene black, Ketjen black, or the like. According to an embodiment, the anode layer and the cathode layer may each include a current collector that collects electrons and sends the electrons to an external conducting wire, and may include, for example, a metal, such as copper, aluminum, or SUS, or a carbon-based material, such as graphene or graphite.

According to an embodiment, the first nanoparticle layer may include OH-GQDs, and the second nanoparticle layer may include a nickel-cobalt-manganese ternary active material (NCM).

According to an embodiment, the first nanoparticle layer and the second nanoparticle layer may include an electrode active material having a structure for intercalation and deintercalation reactions of lithium ions.

According to an embodiment, the nickel-cobalt-manganese ternary active material (NCM) may be doped with GQDs. The GQDs may be used in an amount of 5 parts by weight to 30 parts by weight to dope 100 parts by weight of the nickel-cobalt-manganese ternary active material (NCM).

According to an embodiment, the nickel-cobalt-manganese ternary active material (NCM) may be doped with GQDs, and the GQDs may be used in an amount of 5 parts by weight to 30 parts by weight; 7 parts by weight to 30 parts by weight; 9 parts by weight to 30 parts by weight; 11 parts by weight to 30 parts by weight; 13 parts by weight to 30 parts by weight; 15 parts by weight to 30 parts by weight; 17 parts by weight to 30 parts by weight; 20 parts by weight to 30 parts by weight; 25 parts by weight to 30 parts by weight; 5 parts by weight to 25 parts by weight; 5 parts by weight to 20 parts by weight; 5 parts by weight to 15 parts by weight; 5 parts by weight to 10 parts by weight; 5 parts by weight to 8 parts by weight; 10 parts by weight to 15 parts by weight; and 12 parts by weight to 20 parts by weight, to dope 100 parts by weight of the nickel-cobalt-manganese ternary active material (NCM).

According to an embodiment, when the amount of GQDs to be used to dope 100 parts by weight of the nickel-cobalt-manganese ternary active material (NCM) is less than 5 parts by weight, it may be difficult to improve the ion conductivity due to a limitation on a function of increasing the conductivity while protecting defects included in a solid electrolyte matrix, because the GQDs have a structure with an excellent conductivity without defects. When the amount of GQDs to be used to dope 100 parts by weight of the nickel-cobalt-manganese ternary active material (NCM) exceeds 30 parts by weight, an issue of aggregation between the GQDs may occur, which may cause an issue of an interface resistance between the solid electrolyte and cathode materials.

According to an embodiment, the first nanoparticle layer and the second nanoparticle layer may each have a thickness of 10 μm to 70 μm.

According to an embodiment, the first nanoparticle layer and the second nanoparticle layer may each have a thickness of 10 μm to 70 μm; 20 μm to 70 μm; 30 μm to 70 μm; 40 μm to 70 μm; 50 μm to 70 μm; 60 μm to 70 μm; 10 μm to 60 μm; 10 μm to 50 μm; 10 μm to 40 μm; 10 μm to 30 μm; 10 μm to 20 μm; 20 μm to 40 μm; 30 μm to 50 μm; and 40 μm to 60 μm.

According to an embodiment, when the thickness of each of the first nanoparticle layer and the second nanoparticle layer is less than 10 μm, a composite all-solid-state layer, in which an active material, a conductive material, and a solid electrolyte are mixed, may need to secure both an electronic conduction path and an ion conduction path but an energy density and an output density may decrease due to an isolation of the active material or an isolation of the solid electrolyte, because the active material, the conductive material, and the solid electrolyte do not uniformly disperse, which may lead to a decrease in a capacity. When the thickness of each of the first nanoparticle layer and the second nanoparticle layer exceeds 70 μm, the active material and the solid electrolyte may not uniformly disperse, which may cause an interfacial resistance issue.

According to an embodiment, the first nanoparticle layer may be in an amount of 10 wt % to 40 wt % in the all-solid-state secondary battery, and the second nanoparticle layer may be in an amount of 20 wt % to 60 wt % in the all-solid-state secondary battery.

According to an embodiment, the active material and the solid electrolyte may need to be in smooth contact within the composite all-solid-state layer. Although a sulfide solid electrolyte that is plastically deformable through low-temperature compression due to a great ductility thereof is advantageous over an oxide solid electrolyte in terms of contact with an interface, a control of the interface may be essential to ensure chemical, electrochemical, and mechanical stability at a contact interface due to characteristics of sulfides.

According to an embodiment, the first nanoparticle layer may be in an amount of 10 wt % to 40 wt %; 15 wt % to 40 wt %; 20 wt % to 40 wt %; 25 wt % to 40 wt %; 30 wt % to 40 wt %; 35 wt % to 40 wt %; 10 wt % to 35 wt %; 10 wt % to 30 wt %; 10 wt % to 25 wt %; 10 wt % to 20 wt %; 10 wt % to 15 wt %; 15 wt % to 25 wt %; 20 wt % to 30 wt %; and 25 wt % to 35 wt % in the all-solid-state secondary battery.

According to an embodiment, when the amount of the first nanoparticle layer in the all-solid-state secondary battery is less than 10 wt %, a quantum dot doping effect may not appear. When the amount of the first nanoparticle layer in the all-solid-state secondary battery exceeds 40 wt %, an issue of an interface resistance between solid electrolytes may occur.

According to an embodiment, to solve an issue of electrochemical and chemical side reactions at an interface between a cathode active material and the solid electrolyte, a surface of the hybrid solid electrolyte and a surface of the active material may be coated with GQDs in a nano-sized thickness.

According to an embodiment, the second nanoparticle layer may be in an amount of 20 wt % to 60 wt %; 20 wt % to 55 wt %; 20 wt % to 50 wt %; 20 wt % to 45 wt %; 20 wt % to 40 wt %; 20 wt % to 35 wt %; 20 wt % to 30 wt %; 20 wt % to 25 wt %; 25 wt % to 60 wt %; 30 wt % to 60 wt %; 35 wt % to 60 wt %; 40 wt % to 60 wt %; 45 wt % to 60 wt %; 50 wt % to 60 wt %; 55 wt % to 60 wt %; 30 wt % to 40 wt %; 35 wt % to 45 wt %; 40 wt % to 50 wt %; and 45 wt % to 55 wt % in the all-solid-state secondary battery.

According to an embodiment, when the amount of the second nanoparticle layer in the all-solid-state secondary battery is less than 20 wt %, an issue of an electrochemical side reaction may occur. When the amount of the second nanoparticle layer in the all-solid-state secondary battery exceeds 60 wt %, an issue of the interface resistance may occur.

According to an embodiment, the all-solid-state secondary battery may have a capacity retention of 96.9% or greater after “500” cycles at 25° C.

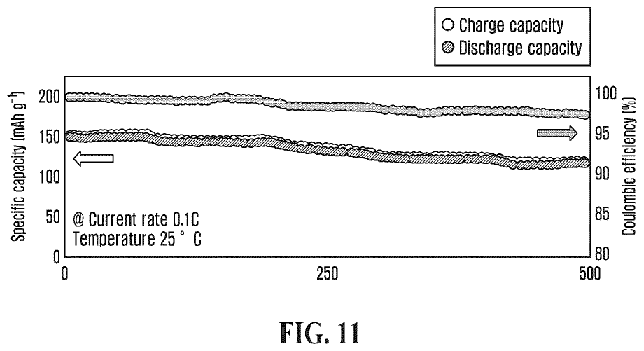

FIG. 11 illustrates a discharge capacity of an all-solid-state secondary battery for “500” cycles under a condition of 0.1 C at 300 K according to an embodiment.

Referring to FIG. 11, the discharge capacity for “500” cycles under the condition of 0.1 C at 300 K is illustrated to identify lifespan characteristics of the all-solid-state secondary battery.

The all-solid-state secondary battery shows a higher overall capacity and capacity retention over long-term cycles in comparison to batteries to which existing Li₆PS₅Cl electrolytes and LLZO electrolytes are applied, and a battery using a solid electrolyte doped with 5 parts by weight of GQDs with a size of 5 nm exhibits the most excellent performance. It may be confirmed that the capacity retention of the all-solid-state secondary battery with the applied solid electrolyte after “500” cycles increased from 78.7% to 96.9%, in comparison to batteries to which existing Li₆PS₅Cl (x=0) electrolytes and LLZO electrolytes are applied.

The all-solid-state secondary battery utilizing the solid electrolyte showed an overall higher discharge capacity and improved lifespan characteristics in comparison to an all-solid-state battery utilizing an existing solid electrolyte, however, when at least 30 parts by weight of GQDs are used for doping, the lithium ion conductivity of the solid electrolyte may decrease and a resistance may increase due to a generation of impurities such as Li₂S within the structure, thereby reducing performance of cells.

Hereinafter, the present disclosure will be described in more detail based on examples and comparative examples.

However, the following examples are only for illustrating the present disclosure, and the present disclosure is not limited to the following examples.

### Experimental Example 1: Materials of Hybrid all-Solid-State Secondary Battery and Method of Analyzing Characteristics of Secondary Battery

X-ray diffraction (XRD) of sintered pellets was performed at a diffractometer (Bruker, D2 Phaser) with a Bragg-Brentano configuration using Cu Kα radiation and a Ni filter. Powders and sintered pellets were measured in an angular range of 10 to 80 degrees with a step size of 0.02° and a counting time of 2 seconds. Microstructural characteristics of synthesized powders were analyzed by scanning electron microscopy (SEM, Hitachi, TM3000) coupled with an energy dispersive X-ray spectroscopy (EDS, Bruker, Quantax 70). Images of the dense pellets were obtained by SEM after heat treatment, and accordingly, at least “300” particles per sample were measured to evaluate a microstructure and to determine an average particle size. For a measurement of impedance, gold (Au) electrode layers were deposited on both sides of a pellet using physical vapor deposition (PVD) technology (MBraun, EcoVap 5G). To avoid an undesirable reaction on a surface of a sample that may occur due to an exposure to moisture and CO₂, electrode deposition and sample assembly were performed in a glove box under argon. An ion conductivity was measured by an impedance spectrometer (Biologic, SP 200) in a frequency range of 1 kHz to 10 MHz with an amplitude of 10 mV. Such a measurement was performed in a vacuum oven at a temperature of 25 to 80° C.

### Experimental Example 2: Preparation of Hybrid Solid Electrolyte

A sulfide-based solid electrolyte and an oxide-based solid electrolyte were synthesized using a mechanical milling method, to synthesize a solid electrolyte for manufacturing of a hybrid all-solid-state secondary battery.

Lithium sulfide (Li₂S, 99.9%, Alfa Aesar), phosphorus pentasulfide (P₂S₅, 99%, SIGMA-ALDRICH), lithium chloride (LiCl, 99%, SIGMA-ALDRICH), and GQDs were used as precursors.

A composition of the solid electrolyte is based on argyrodite (Li₆PS₅Cl), P₂S₅ and GQDs were substituted in a molar ratio of 1:0.5, and Li₂S was added in an amount two to four times a GQD substitution amount, to adjust a charge neutrality of a material. Precursors with a composition of Li₆₊₂ₓGQDₓP₁₋ₓS₅Cl (x=0, 0.0125, 0.025, 0.05, 0.075, 0.1, 0.125, 0.15) were added, and a mechanochemical reaction was induced using a mechanical mill (planetary ball mill, e.g., Pulverisette 5), to synthesize an electrolyte in an amorphous state. Zirconia balls (with a diameter of 5 mm) were combined with precursors in a zirconia container with a volume of 200 ml, using heptane as a solvent, and a milling process was performed “100” times for 30 minutes at 500 rpm. Subsequently, a heat treatment was performed on a glass electrolyte for 6 hours at 570° C. under an argon (Ar) atmosphere, to synthesize a crystalline solid electrolyte. Since a sulfide-based solid electrolyte decomposes while generating H2S gas by reacting with moisture in the air, a synthesis process was performed in a glove box under an inert Ar atmosphere.

An oxide-based (e.g., an LLZO) solid electrolyte was generated by a solid reaction synthesis.

Li₂CO₃ (Sigma-Aldrich, St. Louis, MO, USA), La₂O₃ (Sigma-Aldrich, St. Louis, MO, USA), and ZrO₂ (Sigma-Aldrich, St. Louis, MO, USA) were ball-milled in a planetary ball mill machine (Retsch, PM 100) using zirconia balls with a diameter of 10 mm immersed in isopropyl alcohol.

Heat treatment was performed at 400° C. for 2 hours before grinding to remove moisture absorbed due to hygroscopicity of La₂O₃. A weight of the raw materials was measured at a molar ratio of Li:La:Zr of x:3:2 where x has values of “6.5,” “7.5,” and “8.5.” All precursor materials were mixed using ball milling in ethanol (99.9%) at 300 rpm for 3 hours. A second milling was performed at 500 rpm for 4 hours, and heat treatments were consecutively performed through two steps at 400° C. for 1 hour and 500° C. for 6 hours. A third milling was performed at 600 rpm for 2 hours, and powders were calcined at 550° C. for 8 hours. The calcined powders were reground at various rotation speeds (e.g., 200, 300, 400, and 500 rpm) for 2 hours and compressed into pellets at 50 to 150 MPa. The obtained pellets were covered with the same mother powder in a MgO crucible and sintered at 550° C. for 60 minutes. Lastly, an LLZO solid solution was ball-milled at 300 rpm for 15 minutes to minimize agglomeration of powders.

### Experimental Example 3: Preparation of Cathode Material Nanoparticles/Anode Material Nanoparticles

Li[NiₓCo_{y}Mn_{z}]O₂, a cathode material, is a ternary cathode material and shows differences in capacity and lifespan characteristics depending on a change in a composition ratio of metals.

Accordingly, the size of particles was controlled based on a control of a reaction condition during a reaction, and cathode materials were synthesized by changing a proportion of transition metals.

For a synthesis of cathode material nanoparticles, a method of obtaining a final sintered body by including lithium salts in an initial material, and a method of generating an intermediate, mixing lithium salts of LiOH, LiOH·H₂Oz, and Li₂CO₃, and performing a sintering process to obtain a final sintered body were performed in parallel.

The former method is mainly used in a solid phase method and a sol-gel method, and the latter method was utilized in a spray pyrolysis method and a co-precipitation method due to an advantage of increasing a crystallinity of the final sintered body.

In the present disclosure, an intermediate having a composition of LiNiₓMn_{y}Co_{(1.x.y)}O₂ was synthesized using a continuous rotation reactor by mixing and/or selecting a co-precipitation method and a solid-phase method.

GQDs, anode materials, are OH-GQDs. To prepare OH-GQDs, a scheme of using pyrene was employed.

First, 5 g of pyrene and 400 mL of a nitric acid solution were mixed and refluxed at 80° C. for about 12 hours. Subsequently, through filtration and drying, 1,3,6-trinitropyrene was obtained. 5 g of 1,3,6-trinitropyrene and 700 mL of a 0.2 M NaOH solution were mixed and stirred, and a dispersion was additionally prepared through an ultrasonic treatment. The dispersion obtained as described above was hydrothermally treated in a Teflon autoclave at 200° C. for 12 hours, cooled to room temperature, centrifuged at 4,000 RPM for 30 minutes to remove unnecessary carbon, and irradiated with UV light to observe a quantum confinement effect. Finally, it is confirmed that OH-GQDs were successfully prepared.

### Experimental Example 4: Manufacturing of Hybrid all-Solid-State Secondary Battery

FIG. 1 is a diagram illustrating a structure of an all-solid-state secondary battery according to an embodiment.

To manufacture an all-solid-state secondary battery, pellets may need to first be fabricated, and a pellet fabrication process is described below.

NCM cathode nanoparticles, argyrodite-type LPSCL-based nanoparticles, and garnet-type LLZO-based nanoparticles were ball-milled and then heat-treated at 300° C. Densification of the pellets was achieved by a primary heat pressing method. An assembly, that is, a pellet structure was put in a vacuum chamber and heated to 400° C. while applying a pressure.

The temperature remained constant for 15 minutes to reach thermal equilibrium throughout samples and then increased to 450° C. at a heating rate of 20° C. min⁻¹. The pressure continued to increase until the pressure reached 50 MPa and was released after a residence time of 15 minutes. A temperature profile was controlled at a cooling rate of 100° C. min⁻¹. High-density pellets with a thickness of 5 mm were fabricated by the sintering process. To remove residual carbon and organic materials on surfaces of the samples, the samples were heat-treated at 450° C. for 1 hour and then transferred to a glove box (MBraun, UNIlab Pro SP) filled with argon.

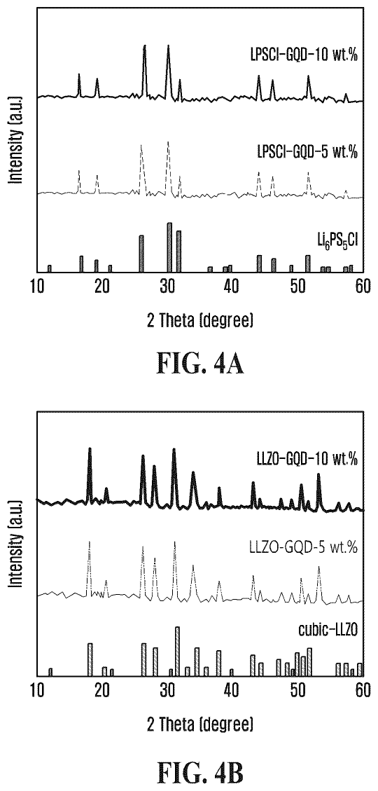

FIGS. 4A and 4B illustrate XRD patterns of sintered pellets of a sulfide solid electrolyte layer and an oxide solid electrolyte layer based on an amount (wt %) of GQDs, respectively, according to an embodiment.

Referring to FIG. 4A, as a result of an XRD analysis of an argyrodite Li₆₊₂ₓGQDₓP₁₋ₓS₅Cl solid electrolyte synthesized by heat treatment per 5 to 10 wt % of GQDs, it was confirmed that all synthesized solid electrolytes had an argyrodite structure. It was confirmed that an amount of unreacted Li₂S to be eluted increased as the amount (wt %) of GQDs increased by 10 wt % or greater. Since the above impurities function to decrease performance in the solid electrolyte and reduce a crystallinity of the solid electrolyte, the ion conductivity of the solid electrolyte and a resistance within a cathode complex may be affected. When the amount (wt %) of GQDs increases by 10 wt % or greater, a change in ionic radius has an influence on a change in a size of a lattice parameter. Therefore, an XRD peak shift may occur as a result of a strain effect within a structure as the amount of GQDs increases.

Referring to FIG. 4B, a structure of the LLZO was successfully synthesized by a solid state reaction as evidenced by physicochemical characteristics. A cubic garnet-type structure was indexed for all diffraction peaks of each powder generated. In a fabricated LLZO structure, a narrow and sharp peak indicates an excellent crystallinity of a material.

Due to matching between experimental XRD results and adjusted profiles achieved through improvement of lattice parameters by a Rietveld method, it was confirmed that the fabricated LLZO structure mainly exhibits a garnet-type crystal structure. After sintering was performed at 450° C. for 3 hours, LLZO sintered pellets exhibited a single phase of a garnet-type structure. If Zr⁴⁺ is replaced with GOD ions and if GQDs are added, a formation of secondary phases such as La₂Zr₂O₇ and LiLa₂ was promoted. After SPS, all samples were heat-treated at 550° C. for 3 hours to remove the secondary phases and residual carbon. Even after the above heat treatment, a great change was not detected in lattice parameters of a garnet structure. Even after heat treatment, that is, a sintering process, most LLZO pellet samples contained cubic phases, and some small peaks of the secondary phase (La₂Zr₂O₇) were also observed. The above results may suggest that an initial concentration of GQDs performs an important function in a formation of a final cubic LLZO pellet, and the amount of GQDs needs to be optimized to a lower limit and an upper limit in which the formation of the secondary phase and the transformation of the cubic phase are possible.

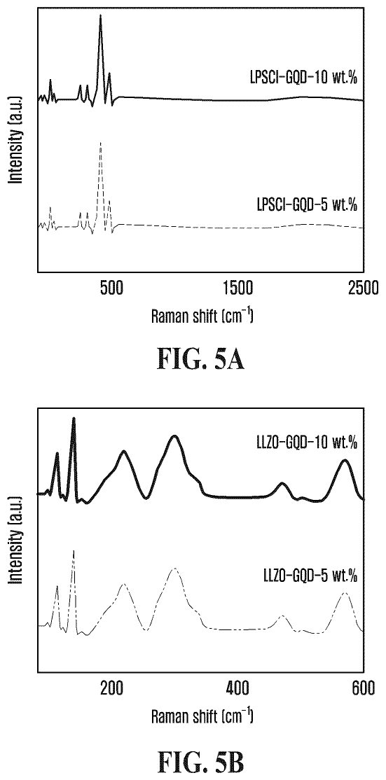

FIGS. 5A and 5B illustrate results of a Raman spectroscopy analysis of a sulfide solid electrolyte layer and an oxide solid electrolyte layer based on an amount (wt %) of GQDs, respectively, according to an embodiment.

FIG. 5A illustrates results of the Raman spectroscopy analysis of a Li₆₊₂ₓGQDₓP₁₋ₓS₅Cl solid electrolyte having an argyrodite crystalline phase, and FIG. 5B illustrates results of the Raman spectroscopy analysis of an LLZO solid electrolyte layer having a garnet-type cubic crystalline phase, to analyze microcrystals of a synthesized solid electrolyte.

Referring to FIG. 5A, a peak around 470 cm⁻¹ corresponds to PS₄³⁻ that is a basic unit in an argyrodite structure. Thus, it can be confirmed that the argyrodite structure continues to be maintained normally even when doping is performed using GQDs. In addition, it was impossible to find a peak related to binding of GQD-S due to doping with GQDs. It is determined that a small amount of GQDs was substituted in a solid electrolyte structure and that it was not detected through a Raman spectroscopy due to similar atomic weights of GQDs and P.

Referring to FIG. 5B, similarly, peaks around 200 and 300 cm⁻¹ appear in the garnet-type cubic crystal phase structure. Thus, it can be confirmed that the garnet-type cubic crystal phase structure continues to be maintained normally even when doping is performed using GQDs.

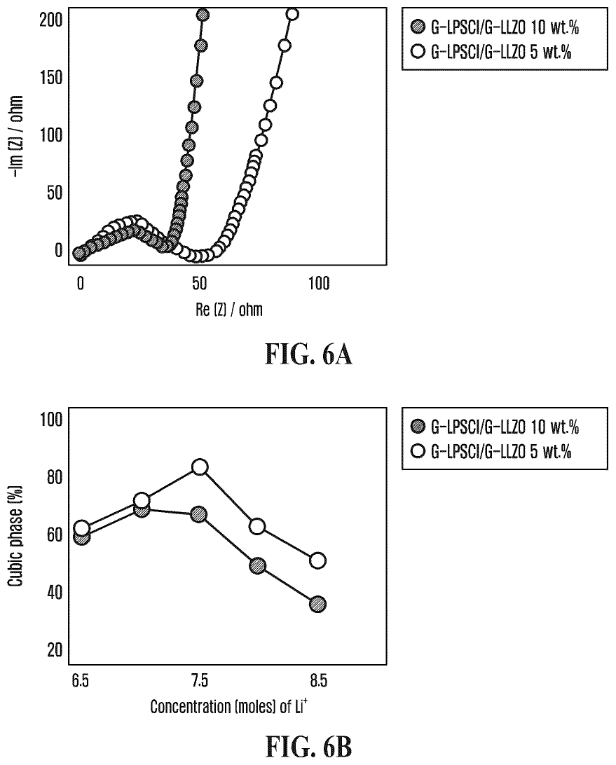

FIG. 6A illustrates results of an electrochemical impedance spectroscopy (EIS) analysis of solid electrolyte pellets, and FIG. 6B illustrates a proportion of a cubic phase based on a molar concentration of lithium ions (Li+), according to an embodiment.

Referring to FIG. 6A, EIS curves of G-LPSCL/G-LLZO pellets prepared by doping with 5 to 10 wt % of GQDs are illustrated. In EIS data, a measured value of an imaginary part (—Z″) was plotted against a real part (Z′) of an impedance, to generate a semicircle that may be related to electrochemical characteristics. Both axes were normalized to a sample dimensional area (S/l) with respect to a thickness, and an ion conductivity was determined by fitting an experimental dataset. A high-frequency semicircle corresponds to the total lithium ion electrical conductivity, and an equivalent electrical circuit and equations were used to extract the ion conductivity. A grain boundary impedance semicircle based on a change in a terminal frequency exhibited a considerably smaller diameter than the other curves of the initial value. In a high-frequency region of a Nyquist plot, two semicircles based on doping with GQDs and a concentration of 5 to 10 wt % of GQDs each correspond to grain boundary resistance according to a terminal frequency. Diffusion tails at an intermediate frequency and a low frequency correspond to Warburg impedance.

Referring to FIG. 6B, for each doping type, a pellet with an initial Li concentration of 7.5 mol exhibits a highest conductivity value due to a high-concentration conductive phase (cubic LLZO) without a secondary phase. Despite a high proportion of the cubic phase in a structure, a sample at a low amount of Li (x=6.5) exhibited a lower Li ion conductivity than a sample with an optimized Li concentration (x=7.5) due to a presence of lanthanum (La). In response to an increase in the amount of Li to 8.5 mol, a tetragonal structure became dominant in a crystal structure of a pellet due to a phase transition, which led to a decrease in the ion conductivity. In particular, a 5 wt % GQD transition metal-doped LLZO structure sample exhibited the best ion conductivity (3.1×10⁻⁴ S cm⁻¹), whereas a 10 wt % GQD-doped LLZO exhibited an ion conductivity of about 2.2×10⁻⁴ S cm⁻¹. At the same Li concentration, a 5 wt % GQD transition metal-doped sample exhibited better Li ion conductivity than that of a 10 wt % GQD-doped sample.

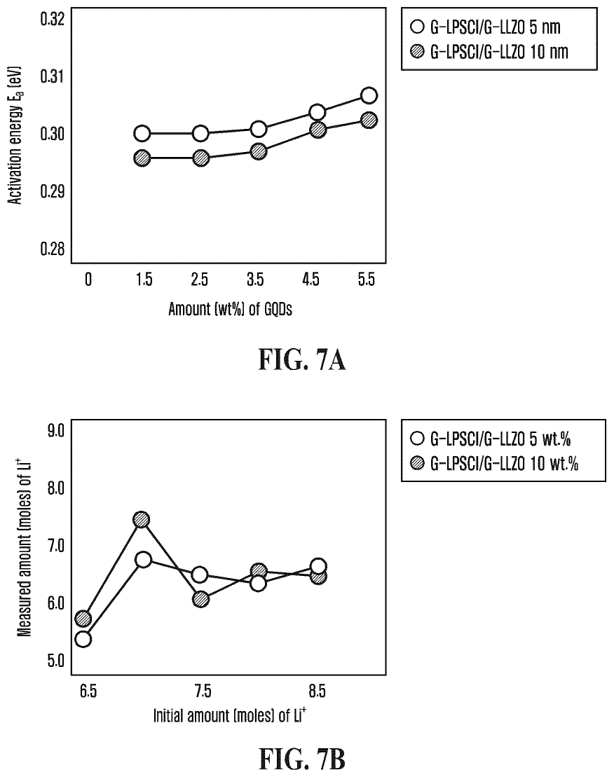

FIG. 7A illustrates activation energy of solid electrolyte pellets based on an amount (wt %) of GQDs, and FIG. 7B illustrates a change in an amount of lithium ions (Li⁺) after the solid electrolyte pellets are sintered and analyzed through an inductively coupled plasma atomic emission spectroscopy (ICP-AES) measurement, according to an embodiment.

Referring to FIGS. 7A and 7B, phase compositions of all powders and pellet samples were analyzed using an XRD Rietveld refinement method, and changes in a concentration of a cubic phase in samples, to which doping with GQDs and different concentrations of GQDs were applied, were confirmed.

Referring to FIG. 7A, in the case of powder samples, despite a small amount of GQDs, a formation of a cubic phase of a GQD-doped LLZO may be reduced due to a secondary phase. An LLZO with 10 wt % of GQDs exhibited a relatively high proportion of the cubic phase than an LLZO with 5 wt % of GQDs. When an initial concentration of GQDs increased to 5 wt % or greater, a mono-doped LLZO structure was formed. In addition, a GQD-doped LLZO structure promoted a more excellent cubic phase stability after sintering of pellets. Results of an XRD Rietveld refinement analysis showed that the proportion of the cubic phase of the LLZO increased from 67% to 75% or greater when the concentration GQDs increased from 5 wt % to 10 wt %.

When the concentration of GQDs increased from 10 wt % to 20 wt %, the proportion of the cubic phase of the LLZO actually decreased from 88% to 72%. When the concentration of GQDs was in a range of 5 to 10 wt %, the highest proportion of the cubic phase was observed, which demonstrates the advantage of an addition of optimized GQDs together with doping with GQDs. Thus, a formation and a stability of the cubic phase in both powder samples and pellet samples with LLZO structures were enhanced.

Referring to FIG. 7B, the amount of Li of GQD-doped LLZO powders and sintered pellets analyzed through the ICP-AES measurement is illustrated. After all powders were calcinated at 550° C. for 3 hours, the amount of Li changed. A low concentration of Li observed in 10 wt % GQD-doped LLZO powders, in comparison to 5 wt % GQD-doped LLZO powders with an initial amount of Li of 6.5 and 7.5 moles may be attributed to a more effective replacement of Li sites by an appropriate amount of GQDs. A structure of the 10 wt % GQD-doped LLZO powders showed a smaller variation in the amount of Li than a relatively high amount of GQDs. This indicates that doping was introduced into LLZO powders prepared with 5 to 10 wt % of GQDs described above and sintering was performed so that the GQDs functioned as an efficient protective film on Li sites of the LLZO structure.

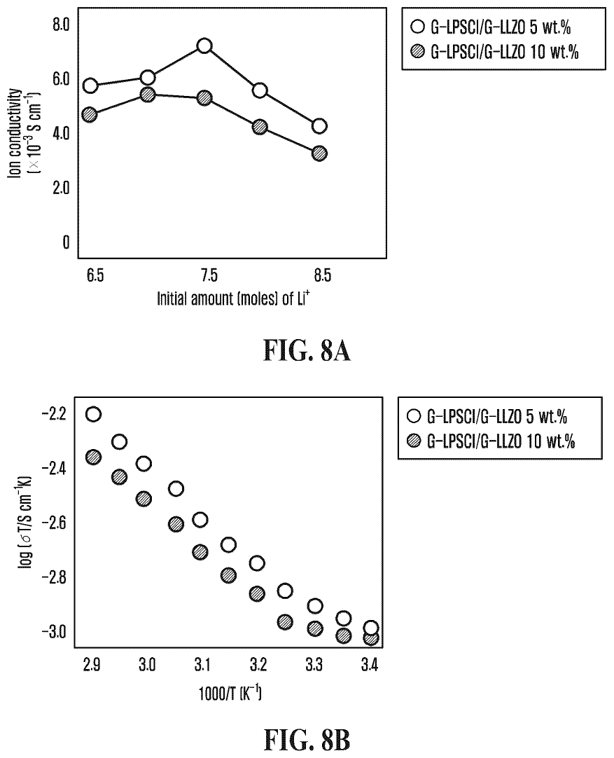

FIGS. 8A and 8B illustrate results obtained by measuring lithium ion conductivities of solid electrolyte pellets at room temperature using an alternating current impedance analysis according to an embodiment.

Referring to FIGS. 8A and 8B, results obtained by measuring lithium ion conductivities of solid electrolyte G-LPSCL/G-LLZO pellets based on an amount (wt %) of GQDs at room temperature using the alternating current impedance analysis are illustrated.

As the amount (wt %) of GQDs in a solid electrolyte increases, the lithium ion conductivity tends to slightly decrease. It is determined that a decrease in the lithium ion conductivity is affected by Li₂S unreacted and eluted in the solid electrolyte as the amount (wt %) of GQDs increases. However, it was confirmed that, since a structure of the G-LPSCL/G-LLZO electrolyte showed a high lithium ion conductivity of about 7.3×10⁻³ S/cm, the ion conductivity of the G-LPSCL/G-LLZO electrolyte is excellent in comparison to general existing oxygen and nitrogen substituted-argyrodite. The lithium ion conductivity of the G-LPSCL/G-LLZO electrolyte increased due to doping with 10 wt % of GQDs may be attributed to a positive effect of each additional doping with GQDs on the G-LPSCL/G-LLZO electrolyte doped with GQDs having a size of 5 nm. Thus, it can be confirmed that a structure of a 10 wt % GQD-doped LLZO performs an important function in an enhancement of the lithium ion conductivity.

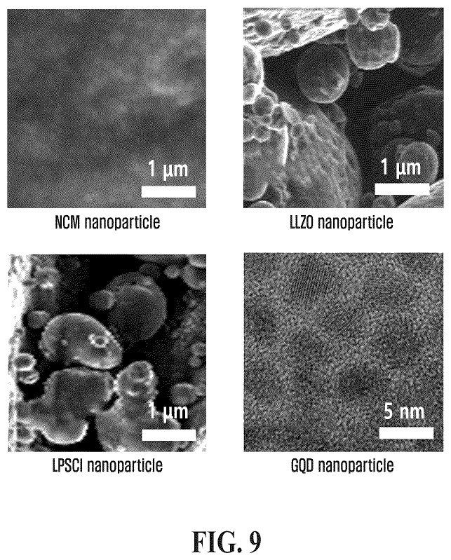

FIG. 9 illustrates images representing characteristics of microstructures for each layer of an all-solid-state secondary battery according to an embodiment.

Referring to FIG. 9, an analysis of characteristics of microstructures for each layer in a hybrid all-solid-state battery revealed micro- and nano-sized spherical particles, as shown in SEM and transmission electron microscopy (TEM) images.

GQD-doped LLZO nanoparticles and NCM nanoparticles exhibited high levels of size distribution and shape uniformity throughout samples in which a cation segregation was not observed. The micron- and nano-sized spherical particles indicate that a final step of a sintering process was completed, and a high heating rate by a current density and a pulse control together with applying of a pressure of an SPS system promoted high nanoparticle size uniformity (>95%). Through an evaluation of microstructures of dense pellets, a high density was confirmed, and a uniform distribution of LLZO nanoparticles with sizes of about 50 to 100 nm and 500 to 1000 nm was confirmed. Through an analysis of an electron microscope, all GQD-doped LLZO pellets at an optimized concentration (5 to 10 wt %) of GQDs exhibited smooth surfaces with small closed pores, whereas a larger number of particle boundaries were observed in samples with an extremely small amount of GQDs or a large size (>20 nm) of GQDs. In addition, crystal defects accompanied by cracks did not appear in LLZO pellets and are generally observed under good sintering conditions of ceramics.

It was confirmed that samples with GQDs having a concentration of 10 wt % and a size of 5 nm were properly sintered at a high density, which may lead to a low grain boundary resistance. Thus, the ion conductivity of the above pellets may be enhanced. However, samples with GQDs having a low concentration (e.g., below 5 wt %) or a high concentration (e.g., 30 wt % or greater) have a large number of grain boundaries and defects, which leads to a reduction in the ion conductivity. Therefore, it can be found that an appropriate initial concentration of GQDs is important to ensure excellent sintering conditions of LLZO pellets.

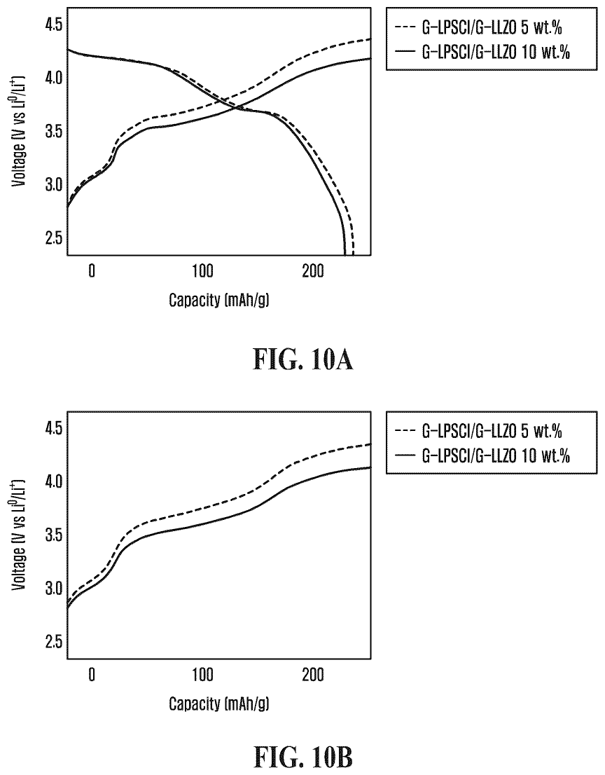

FIGS. 10A and 10B illustrate a charge-discharge profile of an all-solid-state secondary battery formation cycle according to an embodiment.

A charge-discharge experiment was conducted by a constant current (CC) test of 0.1 C at 300 K. A cut-off voltage during charging and discharging was set to a lower limit of 2.75 volts (V) and an upper limit of 4.35 V. It was confirmed that as a proportion of an amount (wt %) of GQDs changed from 10 to 5 wt %, a larger capacity was shown in a 1^{st} cycle. In addition, as the proportion of the amount (wt %) of the GQDs was optimized, a Coulombic efficiency of the 1^{st} cycle also tended to increase.

Based on the above results, it was confirmed that the amount (wt %) of GQDs enhanced an electrochemical stability of the solid electrolyte by suppressing decomposition of electrolytes at an interface between an electrolyte and a cathode active material within a cathode composite in the 1^{st} cycle. The Coulombic efficiency remained unchanged based on the initial number of charge-discharge cycles, and the capacity tended to slightly increase. An initial discharge capacity of the battery was 273.5 mAh g⁻¹, and stabilized at about 268 mAh g⁻¹ after a charge-discharge cycle. Extremely small changes in a major charge-discharge plateau corresponding to a reversible phase transition and defects in a battery structure were observed. The above charge-discharge plateau is noteworthy in comparison to those of batteries using existing high-performance solid electrolytes. This is because of an effective lithium-ion diffusion behavior at an interface between different materials due to doping with GQDs and a relatively low interface resistance of the all-solid-state secondary battery.

Through the above experiment, it was confirmed that the all-solid-state secondary battery with an applied electrolyte having a structure of GQD-doped G-LPSCL/G-LLZO had the most excellent performance.

Therefore, an LPSCL that is an argyrodite-type sulfide-based solid electrolyte, and LLZO that is a garnet-type oxide-based solid electrolyte, were generated to form a hybrid garnet structure solid electrolyte with a high-ion conductivity.

In addition, since sintering is performed using a dry method, that is, a plasma heat treatment method and a pulsed laser annealing method, instead of using a wet method, a synthesis may be performed through a solid particle reaction and high-density pellets may be produced at a relatively low temperature (550° C. or less) and a relatively short heat treatment reaction time (4 hours or less), and thus, it is useful for low-cost mass production processes.

While the embodiments are described, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A solid electrolyte comprising:
an oxide solid electrolyte layer; and
a sulfide solid electrolyte layer,
wherein the oxide solid electrolyte layer and the sulfide solid electrolyte layer are doped with graphene quantum dots (GQDs).

2. The solid electrolyte of claim 1, wherein the oxide solid electrolyte layer comprises at least one selected from a group consisting of a lithium lanthanum zirconium oxide (LLZO), lithium perovskite, a lithium superionic conductor (LISICON), lithium garnet, doped lithium garnet, and a mixture thereof.

3. The solid electrolyte of claim 1, wherein the sulfide solid electrolyte layer comprises at least one selected from a group consisting of an amorphous lithium phosphorus sulfur chloride (LPSCl)-based solid electrolyte, a crystalline LPSCl-based solid electrolyte, and an amorphous and crystalline LPSCl-based solid electrolyte.

4. The solid electrolyte of claim 1, wherein the oxide solid electrolyte layer and the sulfide solid electrolyte layer each have a thickness of 0.1 micrometers (μm) to 50 μm.

5. The solid electrolyte of claim 1, wherein the GQDs are used in an amount of 5 parts by weight to 30 parts by weight to dope 100 parts by weight of the oxide solid electrolyte layer and the sulfide solid electrolyte layer.

6. The solid electrolyte of claim 1, wherein
the GQDs have a diameter of 5 nanometers (nm) to 50 nm, and
the GQDs have a crystalline structure, or have an amorphous region of 5% or less in a structure of the GQDs.

7. The solid electrolyte of claim 1, wherein
the oxide solid electrolyte layer is in an amount of 10% by weight (wt %) to 90 wt % in the solid electrolyte, and
the sulfide solid electrolyte layer is in an amount of 10 wt % to 90 wt % in the solid electrolyte.

8. The solid electrolyte of claim 1, wherein the solid electrolyte has a lithium ion conductivity of 1×10⁻⁴ siemens per centimeter (S/cm) to 9×10⁻³ S/cm.

9. An all-solid-state secondary battery comprising:
an anode layer;
a first nanoparticle layer formed on the anode layer;
a solid electrolyte layer formed on the first nanoparticle layer;
a second nanoparticle layer formed on the solid electrolyte layer; and
a cathode layer formed on the second nanoparticle layer,
wherein the solid electrolyte layer comprises the solid electrolyte of claim 1.

10. The all-solid-state secondary battery of claim 9, wherein
the first nanoparticle layer comprises hydroxyl group-containing graphene quantum dots (OH-GQDs), and
the second nanoparticle layer comprises a nickel-cobalt-manganese ternary active material (NCM).

11. The all-solid-state secondary battery of claim 10, wherein
the nickel-cobalt-manganese ternary active material (NCM) is doped with graphene quantum dots (GQDs), and
the GQDs are used in an amount of 5 parts by weight to 30 parts by weight to dope 100 parts by weight of the nickel-cobalt-manganese ternary active material (NCM).

12. The all-solid-state secondary battery of claim 9, wherein the first nanoparticle layer and the second nanoparticle layer each have a thickness of 10 micrometers (μm) to 70 μm.

13. The all-solid-state secondary battery of claim 9, wherein
the first nanoparticle layer is in an amount of 10% by weight (wt %) to 40 wt % in the all-solid-state secondary battery, and
the second nanoparticle layer is in an amount of 20 wt % to 60 wt % in the all-solid-state secondary battery.

14. The all-solid-state secondary battery of claim 9, wherein the all-solid-state secondary battery has a capacity retention of 96.9% or greater after “500” cycles at 25° C.
